(19) United States
(12) Patent Application Publication
(10) Pub. No.: US 2022/0334367 A1
(43) Pub. Date: Oct. 20, 2022

(54) LASER DEVICE, AND LASER PROCESSING DEVICE IN WHICH SAME IS USED

(71) Applicant: Panasonic Intellectual Property Management Co., Ltd., Osaka (JP)

(72) Inventors: HISAYUKI OGUCHI, Hyogo (JP); RYO ISHIKAWA, Osaka (JP); HIROAKI SUZUKI, Osaka (JP)

(21) Appl. No.: 17/810,841

(22) Filed: Jul. 6, 2022

Related U.S. Application Data
(63) Continuation of application No. PCT/JP2020/048899, filed on Dec. 25, 2020.

(30) Foreign Application Priority Data
Jan. 15, 2020 (JP) 2020-004770

(51) Int. Cl. G02B 19/00; G02B 27/10; G02B 6/42; B23K 26/06; B23K 26/082

(52) U.S. Cl. CPC G02B 19/0047; G02B 27/1006; G02B 6/4206; G02B 19/0009; B23K 26/0608; B23K 26/0617; B23K 26/0648; B23K 26/082; G02B 26/105

(57) ABSTRACT

Laser device (100) includes first and second laser oscillators (1), (2) that respectively emit first and second laser lights (LB1), (LB2) having first and second wavelengths, and first and second optical systems (10), (20). First optical system (10) is configured to couple first and second laser lights (LB1), (LB2) to transmit the first and second laser lights to second optical system (20), and second optical system (20) is configured to condense first laser light (LB1) at first condensing position (FP1) and second laser light (LB2) at second condensing position (FP2). A maximum angle formed by an optical axis and an outermost component of first laser light (LB1) emitted from first optical system (10) is different from a maximum angle formed by an optical axis and an outermost component of the second laser light (LB2).

This application is a continuation of the PCT International Application No. PCT/JP2020/048899 filed on Dec. 25, 2020, which claim the benefit of foreign priority of Japanese patent application No. 2020-004770 filed on Jan. 15, 2020, the contents all of which are incorporated herein by reference.

### TECHNICAL FIELD

The present disclosure relates to a laser device and a laser processing device using the same.

### BACKGROUND ART

Conventionally, laser processing devices that perform processing such as welding using laser light have been widely used, and among them, a laser processing device that performs processing using laser light including a plurality of wavelength components has been proposed (See, for example, PTL 1.).

### CITATION LIST

### Patent Literature

PTL 1: Unexamined Japanese Patent Publication No. 2014-079802

### SUMMARY OF THE INVENTION

### Technical Problem

In the conventional laser processing device disclosed in PTL 1, laser light having different wavelengths is condensed at different positions according to chromatic aberration of an optical system of a laser head. Therefore, positions of a collimating lens and a condensing lens included in the optical system are adjusted to adjust a size of a condensing region of the laser light having different wavelengths.

However, depending on a material and a shape of a workpiece and a type of processing such as cutting or welding, it has been required to set condensing positions of two laser lights to the same position or to move them away from each other.

The present disclosure has been made in view of such a point, and an object thereof is to provide a laser device capable of adjusting condensing positions of two laser lights having different wavelengths with a simple configuration, and a laser processing device using the laser device.

### Solution to Problem

In order to achieve the above object, a laser device according to the present disclosure includes at least: a first laser oscillator that emits first laser light having a first wavelength; a second laser oscillator that emits second laser light having a second wavelength; a first optical system; and a second optical system, wherein the first optical system is configured to couple the first laser light and the second laser light and transmit the first laser light and the second laser light to the second optical system, the second optical system is configured to condense the first laser light emitted from the first optical system at a first condensing position and the second laser light emitted from the first optical system at a second condensing position, and a maximum angle θ1 formed by an optical axis and an outermost component of the first laser light emitted from the first optical system is different from a maximum angle θ2 formed by an optical axis and an outermost component of the second laser light emitted from the first optical system.

A laser processing device according to the present disclosure includes at least: the laser device; and a laser head that emits the first laser light and the second laser light toward a workpiece, wherein the second optical system is disposed inside the laser head.

### Advantageous Effects of Invention

According to the laser device of the present disclosure, it is possible to adjust the first condensing position and the second condensing position to a desired positional relationship with respect to the first laser light and the second laser light.

According to the laser processing device of the present disclosure, a positional relationship between the first condensing position and the second condensing position can be adjusted according to a processing type of the workpiece, and desired processing can be performed on the workpiece.

### BRIEF DESCRIPTION OF THE DRAWINGS

FIG. 1 is a schematic configuration diagram of a laser device according to a first exemplary embodiment of the present disclosure.

FIG. 2 is an enlarged view of a part surrounded by a broken line in FIG. 1.

FIG. 3A is an example of output control of a first laser oscillator and a second laser oscillator.

FIG. 3B is an example of output control of the first laser oscillator and the second laser oscillator.

FIG. 4 is a diagram illustrating spherical aberration characteristics of a general condensing lens.

FIG. 5 is a diagram illustrating chromatic aberration characteristics of a second optical system.

FIG. 6 is a diagram illustrating a relationship between a numerical aperture of a first optical system and condensing positions of first laser light and second laser light.

FIG. 7 is a schematic configuration diagram of another laser device according to the first exemplary embodiment of the present disclosure.

FIG. 8 is a schematic configuration diagram of a laser device according to a first modification.

FIG. 9 is a schematic configuration diagram of a laser device according to a second modification.

FIG. 10 is a schematic configuration diagram of a laser processing device according to a second exemplary embodiment of the present disclosure.

FIG. 11A is a schematic diagram illustrating beam shapes in the vicinity of condensing positions of the first laser light and the second laser light.

FIG. 11B is a schematic diagram illustrating beam shapes in the vicinity of condensing positions of the first laser light and the second laser light.

### DESCRIPTION OF EMBODIMENT

Hereinafter, exemplary embodiments of the present disclosure will be described in detail with reference to the drawings. The following descriptions of preferable exemplary embodiments are merely illustrative in nature and are not intended to limit the present disclosure, application thereof, or use thereof.

### First Exemplary Embodiment

### [Configuration of Laser Device]

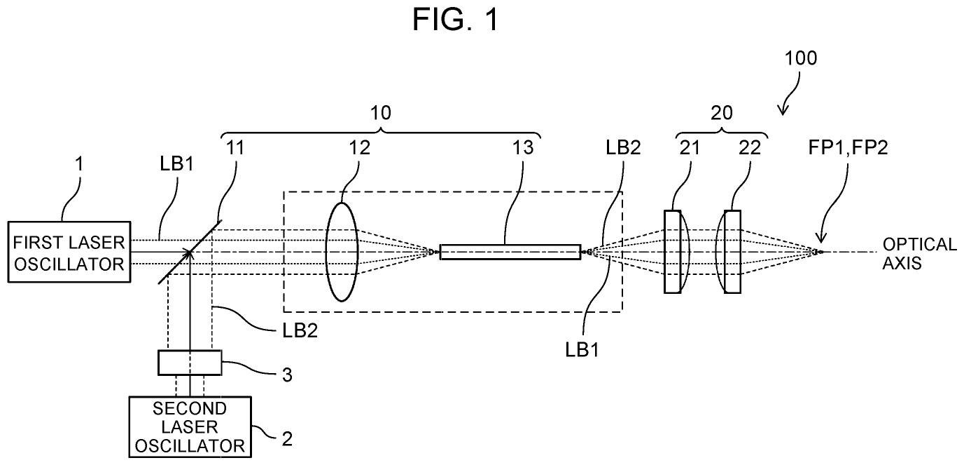

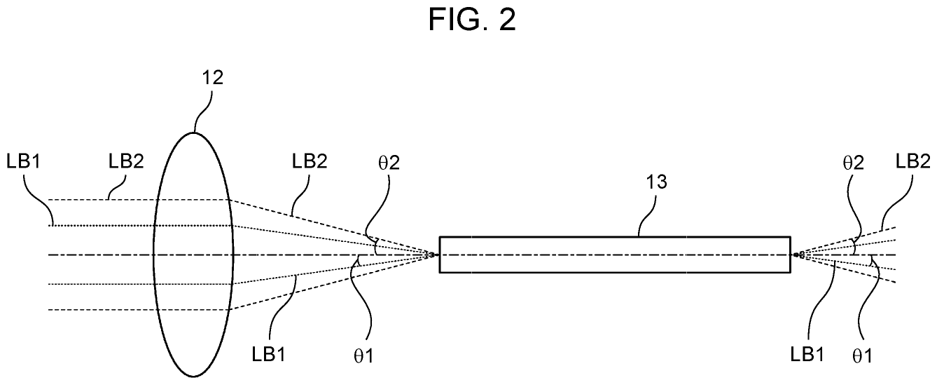

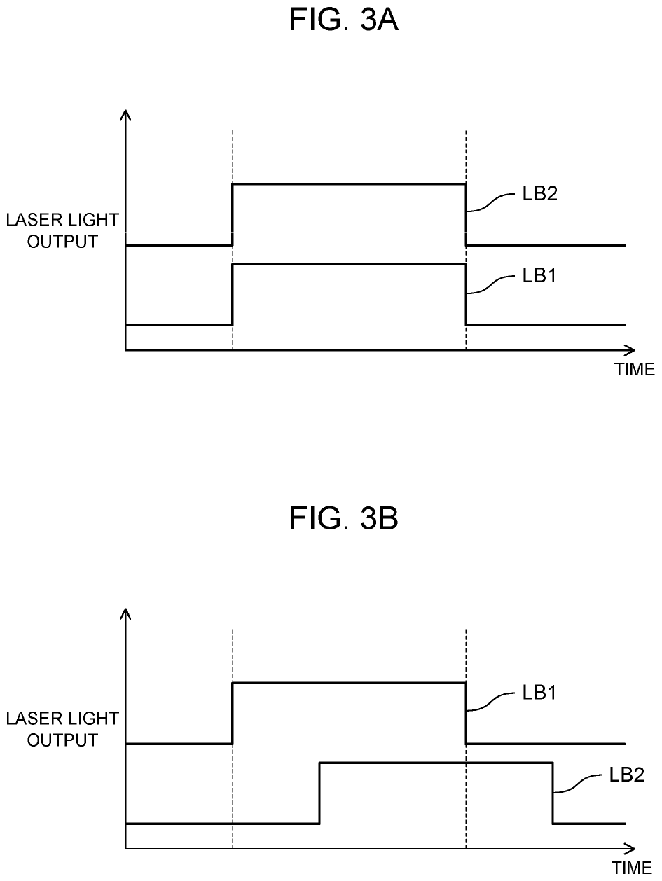

FIG. 1 is a schematic configuration diagram of a laser device according to the present exemplary embodiment, and FIG. 2 is an enlarged view of a part surrounded by a broken line in FIG. 1. FIGS. 3A and 3B illustrate an example of output control of a first laser oscillator and a second laser oscillator. Note that, for convenience of description, illustration and description of components other than the main components of first laser oscillator 1 and second laser oscillator 2, and first optical system 10 and second optical system 20 are omitted in FIG. 1. In addition, laser device 100 illustrated in FIG. 1 includes a housing (not illustrated) for accommodating first optical system 10 and second optical system 20, a power supply for driving first laser oscillator 1 and second laser oscillator 2, a controller that controls outputs of first laser light LB1 and second laser light LB2, and the like.

As illustrated in FIG. 1, laser device 100 includes at least first laser oscillator 1, second laser oscillator 2, first optical system 10, and second optical system 20.

First laser oscillator 1 emits first laser light LB1 having a first wavelength, and second laser oscillator 2 emits second laser light LB2 having a second wavelength. The first wavelength is shorter than the second wavelength, and in the present exemplary embodiment, the first wavelength is about 900 nm and the second wavelength is about 1000 nm. However, the present invention is not particularly limited thereto, and different values can be taken as appropriate.

Further, as illustrated in FIGS. 3A and 3B, first laser oscillator 1 and second laser oscillator 2 are controlled such that a period during which first laser light LB1 is emitted and a period during which second laser light LB2 is emitted entirely overlap (FIG. 3A) or partially overlap (FIG. 3B).

Each of first laser oscillator 1 and second laser oscillator 2 may be a solid-state laser light source, a gas laser light source, or a fiber laser light source. Alternatively, a semiconductor laser light source that directly uses light emitted from a semiconductor laser may be used. Further, a semiconductor laser array including a plurality of laser light emitters may be used.

First optical system 10 includes polarization beam combiner 11 as a beam coupling optical element, first condensing lens 12, and optical fiber 13, and polarization beam combiner 11 is a plate-shaped optical element and is configured to transmit first laser light LB1 and reflect the second laser light LB2.

Polarization beam combiner 11 is disposed such that its surface forms 45 degrees with respect to each of an optical axis of first laser light LB1 emitted from first laser oscillator 1 and an optical axis of second laser light LB2 emitted from second laser oscillator 2. Further, an arrangement relationship among first laser oscillator 1, second laser oscillator 2, and polarization beam combiner 11 is set such that the optical axis of first laser light LB1 after passing through polarization beam combiner 11 substantially coincides with the optical axis of second laser light LB2 after being reflected by polarization beam combiner 11. As a result, when first laser light LB1 and second laser light LB2 are simultaneously emitted, first laser light LB1 and second laser light LB2 are coupled by polarization beam combiner 11, pass on the same optical axis, and enter first condensing lens 12.

Note that, in the specification of the present application, “substantially the same” or “substantially coincide” means the same or coincidence including the manufacturing tolerance of each component in laser device 100 and the allowable tolerance of the arrangement relationship of each component, and does not mean that the two to be compared are the same or coincide with each other in a strict sense.

First condensing lens 12 condenses first laser light LB1 and second laser light LB2 coupled by polarization beam combiner 11, and causes first laser light LB1 and second laser light LB2 to be incident on a core (not illustrated) of optical fiber 13. Optical fiber 13 is an optical member in which a core (not illustrated) that is an optical waveguide is covered with a clad (not illustrated) made of a material having a refractive index lower than that of the core. Optical fiber 13 transmits first laser light LB1 and second laser light LB2 incident on the core to second optical system 20.

Further, magnifying optical system 3 is disposed in an optical path of second laser light LB2 from second laser oscillator 2 toward first optical system 10. Magnifying optical system 3 is configured as a lens group including one or more concave lenses (not illustrated) and one or more convex lenses (not illustrated), and magnifies a beam diameter of second laser light LB2 emitted from second laser oscillator 2 to cause second laser light LB2 to be incident on polarization beam combiner 11 of first optical system 10. In the present exemplary embodiment, optical characteristics of magnifying optical system 3 are set such that the beam diameter of second laser light LB2 incident on polarization beam combiner 11 is larger than a beam diameter of first laser light LB1 incident on polarization beam combiner 11.

Second optical system 20 includes collimating lens 21 and second condensing lens 22, and collimating lens 21 receives first laser light LB1 and second laser light LB2 emitted from optical fiber 13 and converts first laser light LB1 and second laser light LB2 into collimated light.

Second optical system 20 condenses first laser light LB1 at first condensing position FP1 and condenses second laser light LB2 at second condensing position FP2. Note that optical axes of first laser light LB1 and second laser light LB2 emitted from optical fiber 13 to second optical system 20 substantially coincide with each other. Therefore, both first condensing position FP1 and second condensing position FP2 are located on an extension line of the same optical axis. Note that the “condensing position” in the present specification refers to a position where a spot diameter of the laser light is minimized. In addition, first condensing position FP1 refers to a position where the spot diameter of first laser light LB1 emitted from second optical system 20 is minimized, and second condensing position FP2 refers to a position where the spot diameter of second laser light LB2 emitted from second optical system 20 is minimized.

Further, in the present exemplary embodiment, the magnification of second optical system 20 is set to 7 times. The magnification mentioned herein is a ratio between a beam diameter of the laser light incident on second optical system 20 and a beam diameter of the laser light emitted from second optical system 20 at a focal point of second optical system 20. In the present exemplary embodiment, the ratio of the beam diameter of the laser light emitted from optical fiber 13 to the beam diameter at the focal point of the laser light condensed by second condensing lens 22 is set such that the latter is 700 μm when the former is 100 However, the present invention is not particularly limited to this value, and the value can be appropriately changed according to specifications and the like required for laser device 100.

Here, the numerical aperture (NA) of the optical system will be described. When an angle formed by an optical axis of a light beam incident on the optical system or a light beam emitted from the optical system and a component passing through an outermost side of the light beam is defined as a maximum angle θ, and a refractive index of a medium existing around the optical system is defined as n, the numerical aperture NA is expressed by Formula (1) as a general definition.

NA=n×sin θ (1)

Normally, since the optical system is disposed in the air, the refractive index n can be regarded as 1, and NA=sin θ.

Here, it should be noted that the maximum angle θ does not merely depend only on the shape and optical characteristics of the optical system, but also depends on the effective beam diameter when the laser light passes through the optical system. This will be further described with reference to FIG. 2.

As illustrated in FIG. 1, the beam diameter of second laser light LB2 incident on polarization beam combiner 11 is larger than the beam diameter of first laser light LB1 incident on polarization beam combiner 11. Reflecting this, as illustrated in FIGS. 1 and 2, the beam diameter of second laser light LB2 incident on first condensing lens 12 is larger than the beam diameter of first laser light LB1 incident on first condensing lens 12. Further, the optical characteristics of first condensing lens 12 are set such that both first laser light LB1 and second laser light LB2 are condensed at the same condensing position, in this case, an incident end of optical fiber 13.

Therefore, as is clear from FIG. 2, a maximum angle θ2 of second laser light LB2 transmitted through first condensing lens 12 is larger than the maximum angle θ1 of first laser light LB1 transmitted through first condensing lens 12. That is, as is clear from Formula (1), the numerical aperture of first condensing lens 12 for second laser light LB2 is larger than the numerical aperture of first condensing lens 12 for first laser light LB1.

Note that polarization beam combiner 11 does not refract first laser light LB1 and second laser light LB2, and does not change the beam diameter. Further, the maximum angle of the laser light incident on optical fiber 13 is basically maintained when the laser light is emitted from optical fiber 13. Therefore, in laser device 100 illustrated in FIG. 1, the maximum angle θ2 of second laser light LB2 emitted from first optical system 10 is larger than the maximum angle θ1 of first laser light LB1 emitted from first optical system 10. In other words, it can be said that the numerical aperture of first optical system 10 for second laser light LB2 is larger than the numerical aperture of first optical system 10 for first laser light LB1.

Note that the beam diameter of second laser light LB2 incident on first condensing lens 12 needs not to exceed an effective radius unique to first condensing lens 12, that is, the maximum beam diameter on the condensing lens when the incident light beam is condensed at a predetermined position. This is because, when the beam diameter of second laser light LB2 becomes larger than the effective radius of the condensing lens, a part of second laser light LB2 is not incident on optical fiber 13, and there is a risk that light quantity loss occurs and the inside of laser device 100 is damaged. Further, it is preferable that the numerical aperture of first condensing lens 12 for second laser light LB2 does not exceed a numerical aperture NA_{ofb} unique to optical fiber 13. This is because even if the beam diameter of second laser light LB2 is expanded to increase the maximum angle θ2, the maximum angle θ2 of second laser light LB2 emitted from optical fiber 13 is limited by the numerical aperture NA_{ofb} expressed by Formula (2).

NA_{ofb}=sin θ_{ofb}=(n_{core}²−n_{clad}²)^{1/2} (2)

Here, θ_{ofb} is a maximum angle of the light beam emitted from optical fiber 13, n_{core} is a refractive index of the core, and n_{clad} is a refractive index of the clad.

[Relationship Between Optical Characteristics of First and Second Optical Systems and First and Second Condensing Positions]

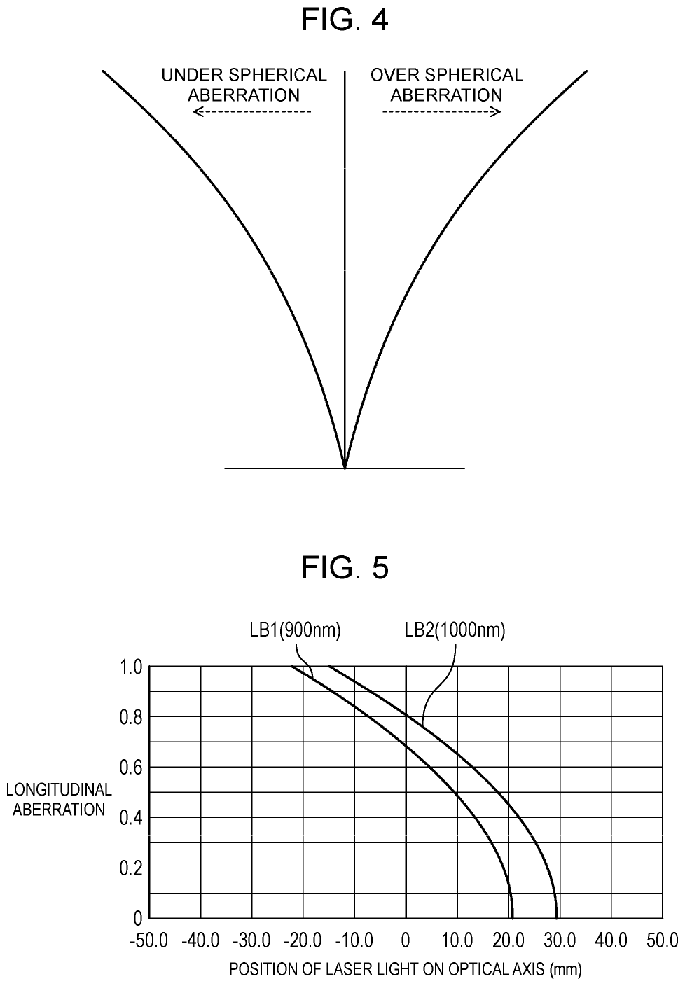

FIG. 4 illustrates spherical aberration characteristics of a general condensing lens, in which a vertical axis indicates longitudinal aberration, that is, the height of the incident light beam from the optical axis, and a horizontal axis indicates an amount of deviation from a focal point of a paraxial light beam incident on the condensing lens. In the horizontal axis, an intersection point with the vertical axis is the focal point of the paraxial light beam incident on the condensing lens.

In general, due to the shape of the condensing lens, in particular, since the condensing lens has a spherical part, a component traveling along the optical axis and a component outside the component are not condensed at the same position in many cases. In such a case, the condensing lens is considered to have spherical aberration.

In FIG. 4, when the spherical aberration characteristics of the condensing lens are represented by a curve located on a left side of the vertical axis, it is said that the condensing lens has under spherical aberration characteristics. In a case where the spherical aberration characteristics of the condensing lens are under, a component on an outer side away from the optical axis among the light beam incident on the condensing lens is focused on a paraxial light beam, that is, a position closer to the condensing lens than the focal point of the light beam passing near the optical axis.

On the other hand, when the spherical aberration characteristics of the condensing lens are represented by a curve located on a right side of the vertical axis, it is said that the condensing lens has over spherical aberration characteristics. In a case where the spherical aberration characteristics of the condensing lens are over, a component on an outer side away from the optical axis in the light beam incident on the condensing lens is focused on a position farther away from the condensing lens than the focal point of the paraxial light beam. Second optical system 20 in the present exemplary embodiment has under spherical aberration characteristics.

Further, the condensing position of the laser light is also related to chromatic aberration of the optical system.

FIG. 5 illustrates chromatic aberration characteristics of the second optical system. Note that a horizontal axis indicates a position of the laser light on the optical axis, and a vertical axis is similar to that illustrated in FIG. 4. In addition, an intersection of the horizontal axis and the vertical axis corresponds to a focal position of the laser light.

When the condensing lens is a convex lens, generally, light having a shorter wavelength is condensed closer to the condensing lens than light having a longer wavelength. This phenomenon is chromatic aberration. Also in second optical system 20 illustrated in the present exemplary embodiment, since second condensing lens 22 is a convex lens, as illustrated in FIG. 5, first laser light LB1 is condensed on a minus side of second laser light LB2, in this case, on a side closer to second condensing lens 22. In the example illustrated in FIG. 5, first laser light LB1 is located closer to second condensing lens 22 by about 10 mm than second laser light LB2. However, this difference depends on the wavelengths of first laser light LB1 and second laser light LB2, the material of second optical system 20, and the above-described magnification, and changes according to the specification of second optical system 20 or the like.

Based on these facts, by appropriately setting the numerical aperture of first optical system 10 and the spherical aberration characteristics of second optical system 20, particularly second condensing lens 22, regarding first laser light LB1 and second laser light LB2, first condensing position FP1 and second condensing position FP2 can be made substantially the same position, or first condensing position FP1 and second condensing position FP2 can be made farther than a difference caused by the chromatic aberration.

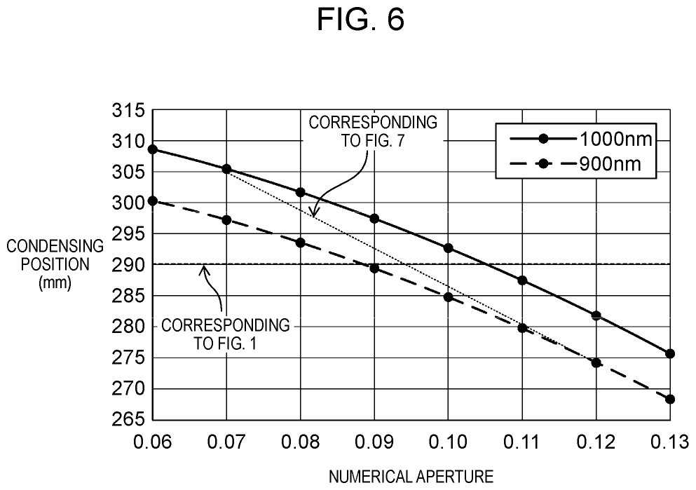

FIG. 6 illustrates an example of a relationship between the numerical aperture of the first optical system and the condensing positions of the first laser light and the second laser light.

As illustrated in FIG. 6, with the same numerical aperture, first laser light LB1 has a smaller condensing position than second laser light LB2, and in this case, first laser light LB1 is condensed on a side closer to second condensing lens 22. Further, when first condensing position FP1 and second condensing position FP2 have the same value, the numerical aperture of first optical system 10 for second laser light LB2 is larger than the numerical aperture of first optical system 10 for first laser light LB1.

Therefore, as illustrated in FIGS. 1 and 2, by making the numerical aperture of first optical system 10 related to second laser light LB2 larger than the numerical aperture of first optical system 10 related to first laser light LB1, it is possible to make first condensing position FP1 and second condensing position FP2 substantially the same position. In the example illustrated in FIG. 6, by setting the numerical aperture of first optical system 10 related to first laser light LB1 to 0.09 and the numerical aperture of first optical system 10 related to second laser light LB2 to 0.105, first condensing position FP1 and second condensing position FP2 become substantially the same position. However, these values can be appropriately changed according to the wavelengths of first laser light LB1 and second laser light LB2 and the spherical aberration characteristics of second optical system 20.

Furthermore, the numerical aperture of first optical system 10 for first laser light LB1 can be made larger than the numerical aperture of first optical system 10 for second laser light LB2.

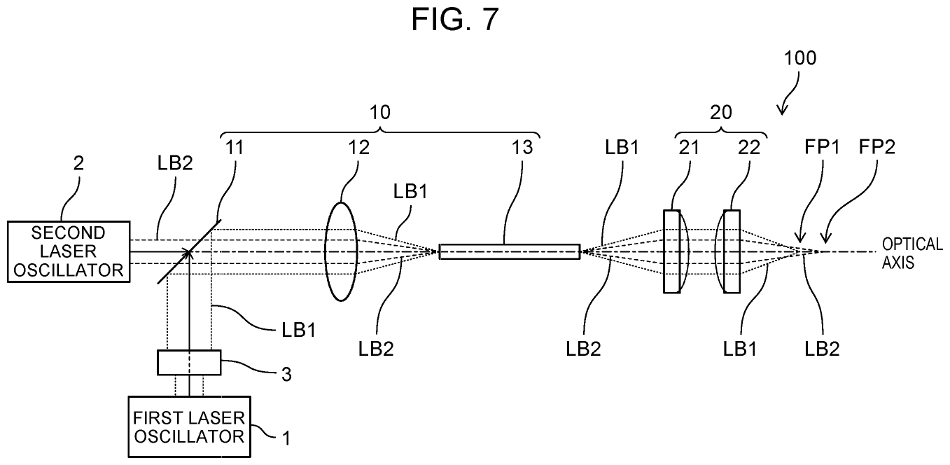

FIG. 7 is a schematic configuration diagram of another laser device according to the present exemplary embodiment, and the same parts as those in FIG. 1 are denoted by the same reference marks and detailed description thereof is omitted.

Laser device 100 illustrated in FIG. 7 is different from laser device 100 illustrated in FIG. 1 in that magnifying optical system 3 is provided between first laser oscillator 1 and polarization beam combiner 11. As a result, in laser device 100 illustrated in FIG. 7, the beam diameter of first laser light LB1 incident on first condensing lens 12 is larger than the beam diameter of second laser light LB2 incident on first condensing lens 12. In this way, the maximum angle θ1 of first laser light LB1 emitted from first optical system 10 is larger than the maximum angle θ2 of second laser light LB2 emitted from first optical system 10. In other words, the numerical aperture of first optical system 10 for first laser light LB1 is larger than the numerical aperture of first optical system 10 for second laser light LB2.

In laser device 100 illustrated in FIG. 7, when the numerical aperture of first optical system 10 related to first laser light LB1 is set to 0.12 and the numerical aperture of first optical system 10 related to second laser light LB2 is set to 0.07, as is clear from FIG. 6, a difference between first condensing position FP1 and second condensing position FP2 is 305-275=30 (mm). This value is clearly larger than a value due to chromatic aberration (10 mm; FIG. 5).

[Effects and the Like]

As described above, laser device 100 according to the present exemplary embodiment includes at least first laser oscillator 1 that emits first laser light LB1 having the first wavelength, second laser oscillator 2 that emits second laser light LB2 having the second wavelength, first optical system 10, and second optical system 20.

First optical system 10 is configured to couple first laser light LB1 and second laser light LB2 to transmit to second optical system 20, and second optical system 20 is configured to focus first laser light LB1 emitted from first optical system 10 on first condensing position FP1 and second laser light LB2 emitted from first optical system 10 on second condensing position FP2.

The maximum angle θ1 formed by the optical axis and the outermost component of first laser light LB1 emitted from first optical system 10 is different from the maximum angle θ2 formed by the optical axis and the outermost component of second laser light LB2 emitted from first optical system 10. In other words, the numerical aperture of first optical system 10 for first laser light LB1 is different from the numerical aperture of first optical system 10 for second laser light LB2.

According to the present exemplary embodiment, regarding first laser light LB1 and second laser light LB2 emitted from second optical system 20, first condensing position FP1 and second condensing position FP2 can be adjusted to a desired positional relationship.

Further, in laser device 100 according to the present exemplary embodiment, the beam diameter of first laser light LB1 incident on first optical system 10 is different from the beam diameter of second laser light LB2 incident on first optical system 10.

In this way, the numerical aperture of first optical system 10 can be easily made different for each of first laser light LB1 and second laser light LB2.

First optical system 10 includes at least polarization beam combiner 11 that is a beam coupling optical element, first condensing lens 12, and optical fiber 13. Polarization beam combiner 11 is configured to couple first laser light LB1 and second laser light LB2, first condensing lens 12 is configured to condense coupled first laser light LB1 and second laser light LB2, and optical fiber 13 is configured to transmit first laser light LB1 and second laser light LB2 to second optical system 20 such that first laser light LB1 and second laser light LB2 are incident on optical fiber 13.

Second optical system 20 includes at least collimating lens 21 and second condensing lens 22. Collimating lens 21 is configured to convert first laser light LB1 and second laser light LB2 emitted from optical fiber 13 into collimated light. Second condensing lens 22 is configured to condense first laser light LB1 having passed through collimating lens 21 at first condensing position FP1, and condense second laser light LB2 having passed through collimating lens 21 at second condensing position FP2.

In this way, first laser light LB1 and second laser light LB2 can be easily condensed at first condensing position FP1 and second condensing position FP2, respectively.

When the first wavelength is shorter than the second wavelength and the spherical aberration characteristics of second optical system 20 are under, first optical system 10 and second optical system 20 are configured such that first condensing position FP1 and second condensing position FP2 are at the same position.

In this case, the maximum angle θ2 is set to be larger than the maximum angle θ1. Further, in order to satisfy this relationship, the beam diameter of second laser light LB2 incident on first optical system 10 is set to be larger than the beam diameter of first laser light LB1 incident on first optical system 10.

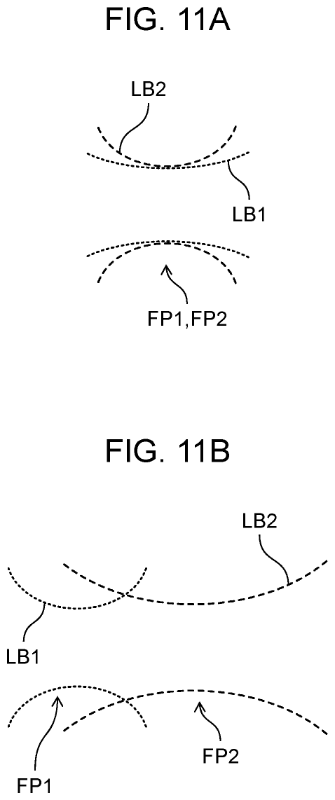

In this way, first laser light LB1 and second laser light LB2 can be condensed at the same position, and when the coupled light of first laser light LB1 and second laser light LB2 is regarded as one laser light, the laser light density at the condensing position can be increased (see FIG. 11A).

When the first wavelength is shorter than the second wavelength and the spherical aberration characteristics of second optical system 20 are under, first optical system 10 and second optical system 20 may be configured such that a difference between second condensing position FP2 and first condensing position FP1 is larger than the value caused by the chromatic aberration of second optical system 20.

In this case, the maximum angle θ1 is set to be larger than the maximum angle θ2. In order to satisfy this relationship, the beam diameter of first laser light LB1 incident on first optical system 10 is set to be larger than the beam diameter of second laser light LB2 incident on first optical system 10.

In this way, when the coupled light of first laser light LB1 and second laser light LB2 is regarded as one laser light, the Rayleigh length of the laser light can be increased (see FIG. 11B).

### First Modification

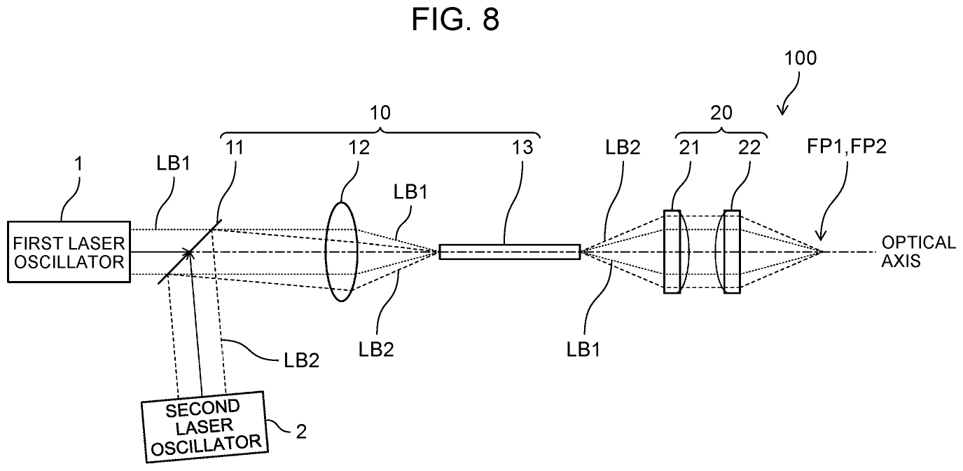

FIG. 8 is a schematic configuration diagram of a laser device according to the present modification, and the same parts as those in FIG. 1 are denoted by the same reference marks, and a detailed description thereof is omitted.

Laser device 100 illustrated in FIG. 8 is different from laser device 100 illustrated in FIG. 1 in the following points. First, magnifying optical system 3 is not provided between second laser oscillator 2 and polarization beam combiner 11. Next, an angle formed by the optical axis of second laser light LB2 emitted from second laser oscillator 2 and a surface of polarization beam combiner 11 is inclined from 45 degrees. In the present modification, the inclination angle is about 2 degrees, but is not limited thereto at times.

As described above, by inclining the optical axis of second laser light LB2 by a predetermined angle as compared with the case illustrated in FIG. 1, an outermost light beam of second laser light LB2 is incident on a position farther from a center of first condensing lens 12 than an outermost light beam of first laser light LB1 as illustrated in FIG. 8. As a result, the maximum angle θ2 of second laser light LB2 transmitted through first condensing lens 12 and incident on optical fiber 13 can be made larger than the maximum angle θ1 of first laser light LB1 transmitted through first condensing lens 12 and incident on optical fiber 13. That is, the numerical aperture of first optical system 10 for second laser light LB2 can be made larger than the numerical aperture of first optical system 10 for first laser light LB1.

Note that, as is clear from FIG. 8, the optical axis of the first laser that travels from polarization beam combiner 11 toward first condensing lens 12 and enters optical fiber 13 is different from the optical axis of the second laser that travels from polarization beam combiner 11 toward first condensing lens 12 and enters optical fiber 13, and is shifted by the inclination angle (about 2 degrees).

According to the present modification, similarly to the case illustrated in FIG. 1, first condensing position FP1 and second condensing position FP2 can be located at substantially the same position. As a result, when the coupled light of first laser light LB1 and second laser light LB2 is regarded as one laser light, the laser light density at the condensing position can be increased (see FIG. 11A).

Note that, when an angle formed by the optical axis of first laser light LB1 emitted from first laser oscillator 1 and a surface of polarization beam combiner 11 is inclined by a predetermined angle from 45 degrees, the maximum angle θ1 of first laser light LB1 transmitted through first condensing lens 12 and incident on optical fiber 13 can be made larger than the maximum angle θ2 of second laser light LB2 transmitted through first condensing lens 12 and incident on optical fiber 13. That is, it goes without saying that the numerical aperture of first optical system 10 for first laser light LB1 can be made larger than the numerical aperture of first optical system 10 for second laser light LB2.

In this way, first condensing position FP1 and second condensing position FP2 can be separated from each other, and the difference can be made larger than a difference caused by the chromatic aberration. As a result, when the coupled light of first laser light LB1 and second laser light LB2 is regarded as one laser light, the Rayleigh length of the laser light can be increased (see FIG. 11B).

### Second Modification

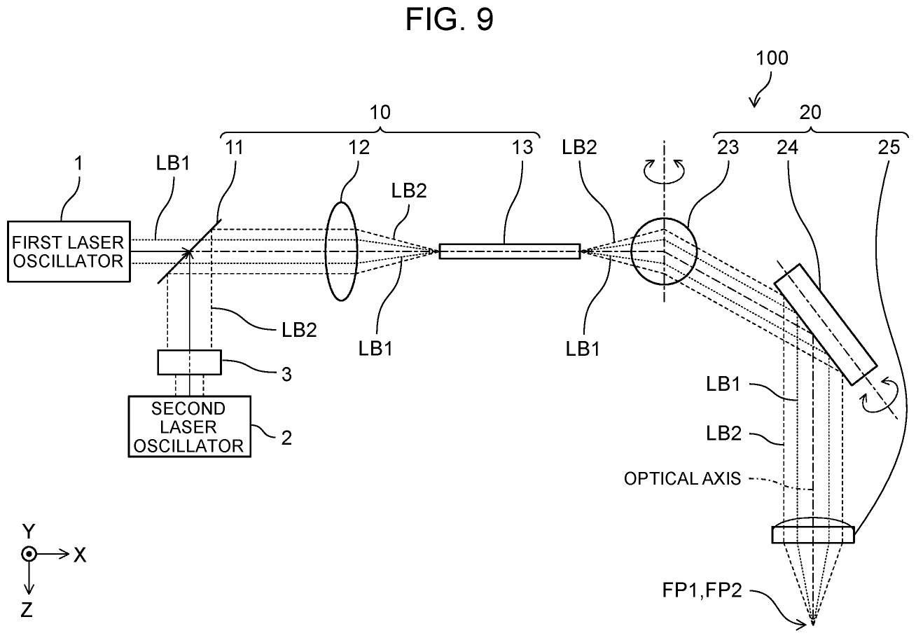

FIG. 9 illustrates a schematic configuration diagram of a laser device according to the present modification, and the same reference marks are given to the same parts as those in FIG. 1, and a detailed description thereof will be omitted.

Laser device 100 illustrated in FIG. 9 is different from laser device 100 illustrated in FIG. 1 in the following points. First, magnifying optical system 3 is not provided between second laser oscillator 2 and polarization beam combiner 11. Next, second optical system 20 includes first mirror 23, second mirror 24, and third condensing lens 25. First mirror 23 and second mirror 24 are so-called galvanometer mirrors.

First mirror 23 is connected to a motor (not illustrated), reflects first laser light LB1 and second laser light LB2 by driving the motor, and scans along an X-direction illustrated in FIG. 9. Second mirror 24 is connected to another motor (not illustrated), and further reflects first laser light LB1 and second laser light LB2 reflected by first mirror 23 by driving of the other motor, and scans along a Y-direction illustrated in FIG. 9.

Third condensing lens 25 receives first laser light LB1 and second laser light LB2 reflected by second mirror 24 and condenses first laser light LB1 and second laser light LB2 at first condensing position FP1 and second condensing position FP2, respectively.

Note that an fθ lens may be used as third condensing lens 25. The fθ lens is a lens having a function of converting incident laser light into a spot diameter having a height corresponding to a radiation angle thereof, in other words, a function of converting a radiation angle distribution of the laser light into a position distribution.

That is, second optical system 20 of the present modification is configured to reflect first laser light LB1 emitted from first optical system 10, scan along a predetermined direction, and condense first laser light LB1 at first condensing position FP1. Further, second laser light LB2 emitted from first optical system 10 is reflected, scanned along a predetermined direction, and condensed at the second condensing position FP2.

Second optical system 20 may be configured as described above, and by providing third condensing lens 25 with under spherical aberration characteristics in advance, first laser light LB1 and second laser light LB2 can be condensed at a condensing position similar to that illustrated in the first exemplary embodiment.

According to the present modification, it is possible to achieve effects similar to those achieved by the configuration of the first exemplary embodiment illustrated in FIGS. 1 and 7. That is, when the coupled light of first laser light LB1 and second laser light LB2 is regarded as one laser light, the laser light density at the condensing position can be increased by setting first condensing position FP1 and second condensing position FP2 to be at substantially the same position (see FIG. 11A).

Further, by making the numerical aperture of first optical system 10 related to first laser light LB1 larger than the numerical aperture of first optical system 10 related to second laser light LB2, first condensing position FP1 and second condensing position FP2 can be separated from each other, and the difference can be made larger than a difference caused by the chromatic aberration. As a result, when the coupled light of first laser light LB1 and second laser light LB2 is regarded as one laser light, the Rayleigh length of the laser light can be increased (see FIG. 11B).

### Second Exemplary Embodiment

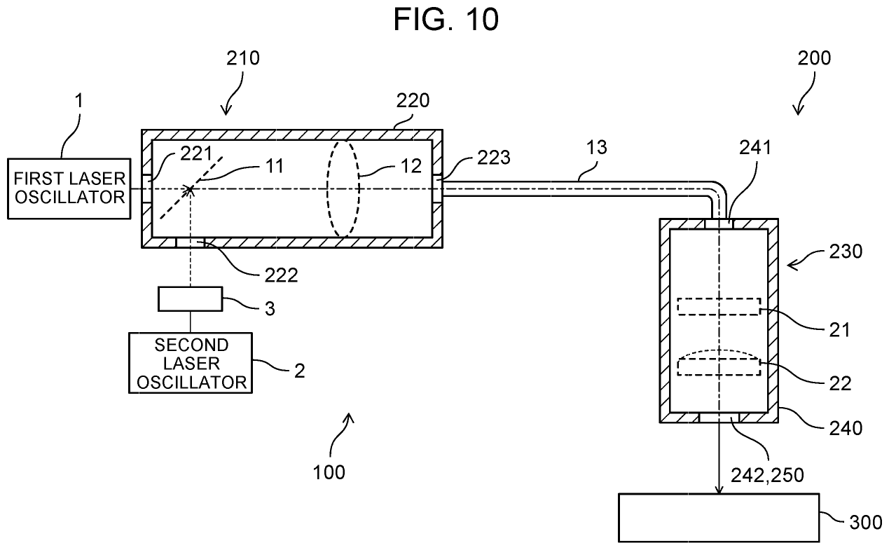

FIG. 10 is a schematic configuration diagram of a laser processing device according to the present exemplary embodiment, and FIGS. 11A and 11B illustrate beam shapes near condensing positions of the first laser light and the second laser light. Note that, for convenience of description, in FIG. 10, the same parts as those in the first exemplary embodiment are denoted by the same reference marks, and detailed description thereof is omitted.

As illustrated in FIG. 10, laser processing device 200 includes first laser oscillator 1, second laser oscillator 2, beam coupler 210, and laser head 230, and first laser oscillator 1 and second laser oscillator 2 have configurations similar to those illustrated in FIG. 1. Therefore, although not illustrated, laser processing device 200 includes a power supply that drives each of first laser oscillator 1 and second laser oscillator 2, and a controller that controls an output of the power supply to control outputs of first laser light LB1 and second laser light LB2.

Beam coupler 210 has a configuration including polarization beam combiner 11 and first condensing lens 12 inside first housing 220, and first housing 220 is provided with first window 221 for transmitting first laser light LB1 emitted from first laser oscillator 1, second window 222 for transmitting second laser light LB2 emitted from second laser oscillator 2, and first connection port 223 for connecting to optical fiber 13. First connection port 223 of first housing 220 and second connection port 241 of second housing 240 of laser head 230 are connected by optical fiber 13.

First laser light LB1 transmitted through first window 221 and second laser light LB2 transmitted through second window 222 are coupled by polarization beam combiner 11 so that their optical axes substantially coincide with each other, and are incident on first condensing lens 12. First laser light LB1 and second laser light LB2 condensed by first condensing lens 12 are condensed toward first connection port 223 to which an end part of optical fiber 13 is connected.

Note that other optical components may be disposed in beam coupler 210. For example, magnifying optical system 3 may be provided inside first housing 220.

Laser head 230 has a configuration including second optical system 20 inside second housing 240, and first laser light LB1 and second laser light LB2 emitted from optical fiber 13 connected to second connection port 241 of second housing 240 are each subjected to predetermined conversion by second optical system 20 and emitted from emission port 242 of second housing 240 toward workpiece 300. Specifically, first laser light LB1 and second laser light LB2 are converted into collimated light by collimating lens 21, and are condensed at first condensing position FP1 and second condensing position FP2 by second condensing lens 22. Note that emission port 242 is provided with protective glass 250 so that fumes and the like do not enter an inside of laser head 230.

According to the present exemplary embodiment, a positional relationship between first condensing position FP1 and second condensing position FP2 can be easily adjusted according to a processing type of workpiece 300. In particular, when workpiece 300 is simultaneously irradiated with first laser light LB1 and second laser light LB2, desired processing can be performed on workpiece 300. As illustrated in FIG. 11A, when first condensing position FP1 and second condensing position FP2 are located at the same position, the laser light density on a surface of workpiece 300 is increased, and for example, drilling or cutting can be performed at high speed.

Further, as illustrated in FIG. 11B, when the coupled light of first laser light LB1 and second laser light LB2 is regarded as one laser light beam, the Rayleigh length of the laser light can be made long by moving first condensing position FP1 away from second condensing position FP2, and processing tolerance for thickness variation of workpiece 300 can be secured. Further, when laser head 230 is moved for processing, processing tolerance against variation in movement of laser head 230 can be secured. As a result, for example, shape stability can be secured in drilling, welding, or the like having a high aspect ratio.

Furthermore, since an optical absorptance of workpiece 300 varies depending on the material and temperature of workpiece 300, for example, second laser light LB2 having a long wavelength may not be sufficiently absorbed by workpiece 300 at the beginning of laser light irradiation, and desired processing may not be performed. In such a case, by simultaneously illuminating workpiece 300 with first laser light LB1 having a high optical absorptance, workpiece 300 is heated to increase the optical absorptance of first laser light LB1 so that desired laser processing can be performed. At this time, when second condensing position FP2 is set in the vicinity of a surface of workpiece 300 while first condensing position FP1 is set to be farther away from second condensing position FP2 than a value caused by the chromatic aberration, and an output of first laser light LB1 is appropriately adjusted, first laser light LB1 can be used only for heating workpiece 300. That is, the processing itself is performed with second laser light LB2, and first laser light LB1 is used for heating workpiece 300 for assisting the processing. This enables high-speed and highly accurate laser processing.

As described above, in laser device 100 used in laser processing device 200, regarding first laser light LB1 and second laser light LB2 having different wavelengths, the numerical aperture of first optical system 10 is made different from each other, so that laser processing according to required specifications and accuracy can be performed.

Further, since second optical system 20 is disposed inside laser head 230 connected to optical fiber 13, even if laser head 230 is moved according to the shape of workpiece 300, first laser light LB1 and second laser light LB2 can be condensed at a desired condensing position without changing the maximum angles θ1 and θ2 with respect to the optical axes of first laser light LB1 and second laser light LB2. Note that laser head 230 may be attached to a robot arm (not illustrated). By moving a distal end of the robot arm so as to draw a predetermined trajectory, laser processing can be performed on workpiece 300 along the predetermined trajectory.

### Other Exemplary Embodiments

Note that a new exemplary embodiment can be formed by appropriately combining the components described in the exemplary embodiments and the modifications. For example, laser devices 100 illustrated in the first and second modifications can also be applied to laser processing device 200 illustrated in the second exemplary embodiment.

In FIG. 1, instead of providing magnifying optical system 3, a reduction optical system for reducing the beam diameter of first laser light LB1 may be provided between first laser oscillator 1 and polarization beam combiner 11. Similarly, in FIG. 7, instead of providing magnifying optical system 3, a reduction optical system for reducing the beam diameter of second laser light LB2 may be provided between second laser oscillator 2 and polarization beam combiner 11.

Note that, in the first and second exemplary embodiments and the first and second modifications, the case where the spherical aberration characteristics of second optical system 20 are under has been described as an example, but the spherical aberration characteristics of second optical system 20 may tend to be over. In this case, the relationship between the numerical aperture and the condensing position is reversed. That is, by making the maximum angle θ2 of second laser light LB2 emitted from first optical system 10 larger than the maximum angle θ1 of first laser light LB1 emitted from first optical system 10, in other words, by making the numerical aperture of first optical system 10 for second laser light LB2 larger than the numerical aperture of first optical system 10 for first laser light LB1, first condensing position FP1 and second condensing position FP2 can be separated from each other. Moreover, the difference can be made larger than a value caused by the chromatic aberration. As a result, when the coupled light of first laser light LB1 and second laser light LB2 is regarded as one laser light, the Rayleigh length of the laser light can be increased.

Further, by making the maximum angle θ1 of first laser light LB1 emitted from first optical system 10 larger than the maximum angle θ2 of second laser light LB2 emitted from first optical system 10, in other words, by making the numerical aperture of first optical system 10 for first laser light LB1 larger than the numerical aperture of first optical system 10 for second laser light LB2, first condensing position FP1 and second condensing position FP2 can be located at substantially the same position. As a result, when the coupled light of first laser light LB1 and second laser light LB2 is regarded as one laser light, the laser light density at the condensing position can be increased.

Furthermore, in laser device 100 illustrated in the second modification, collimating lens 21 may be provided in a preceding stage of first mirror 23, or only one of first mirror 23 and second mirror 24 may be provided.

### INDUSTRIAL APPLICABILITY

Since the laser device of the present disclosure can adjust the condensing positions of two laser lights having different wavelengths with a simple configuration, the laser device of the present disclosure is useful, for example, for application to a laser processing device.

### REFERENCE MARKS IN THE DRAWINGS

1 first laser oscillator
2 second laser oscillator
3 magnifying optical system
10 first optical system
11 polarization beam combiner (beam coupling element)
12 first condensing lens
13 optical fiber
20 second optical system
21 collimating lens
22 second condensing lens
23 first mirror
24 second mirror
25 third condensing lens
100 laser device
200 laser processing device
210 beam coupler
220 first housing
221 first window
222 second window
223 first connection port
230 laser head
240 second housing
241 second connection port
242 emission port
250 protective glass
LB1 first laser light
LB2 second laser light
FP1 first condensing position
FP2 second condensing position

1. A laser device comprising at least:
a first laser oscillator that emits first laser light having a first wavelength;
a second laser oscillator that emits second laser light having a second wavelength;
a first optical system; and
a second optical system, wherein
the first optical system is configured to couple the first laser light and the second laser light and transmit the first laser light and the second laser light to the second optical system,
the second optical system is configured to condense the first laser light emitted from the first optical system at a first condensing position and the second laser light emitted from the first optical system at a second condensing position, and
a maximum angle θ1 formed by an optical axis and an outermost component of the first laser light emitted from the first optical system is different from a maximum angle θ2 formed by an optical axis and an outermost component of the second laser light emitted from the first optical system.

2. The laser device according to claim 1, wherein the first laser light incident on the first optical system has a beam diameter that is different from a beam diameter of the second laser light incident on the first optical system.

3. The laser device according to claim 1, wherein
the first optical system includes at least an optical fiber that transmits the first laser light and the second laser light to the second optical system, and
the first laser light incident on the optical fiber has an optical axis that is different from an optical axis of the second laser light incident on the optical fiber.

4. The laser device according to claim 1, wherein when the first wavelength is shorter than the second wavelength and a spherical aberration characteristic of the second optical system is under, the first optical system and the second optical system are configured to set the first condensing position and the second condensing position at an identical position.

5. The laser device according to claim 1, wherein when the first wavelength is shorter than the second wavelength and a spherical aberration characteristic of the second optical system is under, the first optical system and the second optical system are configured to make a difference between the second condensing position and the first condensing position larger than a value caused by chromatic aberration of the second optical system.

6. The laser device according to claim 1, wherein when the first wavelength is shorter than the second wavelength and a spherical aberration characteristic of the second optical system is over, the first optical system and the second optical system are configured to set the first condensing position and the second condensing position at an identical position.

7. The laser device according to claim 1, wherein when the first wavelength is shorter than the second wavelength and a spherical aberration characteristic of the second optical system is over, the first optical system and the second optical system are configured to make a difference between the second condensing position and the first condensing position larger than a value caused by chromatic aberration of the second optical system.

8. The laser device according to claim 1, wherein
the first optical system includes at least a beam coupling optical element, a first condensing lens, and an optical fiber,
the beam coupling optical element couples the first laser light and the second laser light,
the first condensing lens condenses the first laser light and the second laser light coupled to each other and causes the first laser light and the second laser light to enter the optical fiber,
the optical fiber transmits the first laser light and the second laser light to the second optical system,
the second optical system includes at least a collimating lens and a second condensing lens,
the collimating lens converts each of the first laser light and the second laser light emitted from the optical fiber into collimated light, and
the second condensing lens condenses the first laser light having passed through the collimating lens at the first condensing position and condenses the second laser light having passed through the collimating lens at the second condensing position.

9. The laser device according to claim 1, wherein
the first optical system includes at least a beam coupling optical element, a first condensing lens, and an optical fiber,
the beam coupling optical element couples the first laser light and the second laser light,
the first condensing lens condenses the first laser light and the second laser light coupled to each other and causes the first laser light and the second laser light to enter the optical fiber,
the optical fiber transmits the first laser light and the second laser light to the second optical system,
the second optical system includes at least a galvanometer mirror and a third condensing lens,
the galvanometer mirror reflects the first laser light and the second laser light emitted from the optical fiber and scans the first laser light and the second laser light in a predetermined direction, and
the third condensing lens condenses the first laser light reflected by the galvanometer mirror at the first condensing position and condenses the second laser light reflected by the galvanometer mirror at the second condensing position.

10. The laser device according to claim 8, wherein the beam coupling optical element is a polarization beam combiner that couples the first laser light and the second laser light.

11. The laser device according to claim 1, wherein a period during which the first laser light is emitted from the first laser oscillator overlaps in whole or in part with a period during which the second laser light is emitted from the second laser oscillator.

12. A laser processing device comprising at least:
the laser device according to claim 1; and
a laser head that emits the first laser light and the second laser light toward a workpiece, wherein the second optical system is disposed inside the laser head.
